(19) United States
(12) Patent Application Publication
(10) Pub. No.: US 2014/0253405 A1
(43) Pub. Date: Sep. 11, 2014

(54) ANTENNA OF INVERTED F ANTENNA TYPE INTEGRATED INTO A PRINTED CARD, AND SYSTEM

(71) Applicant: Pascal Leger, Gisors (FR)

(72) Inventor: Pascal Leger, Gisors (FR)

(73) Assignee: Johnson Controls Automotive Electronics SAS

(21) Appl. No.: 14/131,316

(22) PCT Filed: Jul. 6, 2012
(86) PCT No.: PCT/EP2012/002846

§ 371 Date: May 14, 2014

(30) Foreign Application Priority Data
Jul. 8, 2011 (DE) 10 2011 106 936.8
Sep. 14, 2011 (FR) 11/02781

(51) Int. Cl. H01Q 9/04

(52) U.S. Cl. CPC H01Q 9/0407
USPC 343/843; 343/700 MS

(57) ABSTRACT

An IFA type antenna is integrated into a printed card, the printed card having a main-extension plane. The IFA type antenna has a first electrically conducting element, serving as earth plane, a second electrically conducting element, serving as radiating element of the antenna, an electrically conducting connection, serving to short-circuit the first electrically conducting element and the second electrically conducting element, and an excitation element being in electrical contact with the second electrically conducting element. The second electrically conducting element has a first part, a second part and a third part in various planes of the printed card.

The present invention relates first to an IFA (‘Inverted F Antenna’ in English) type antenna being implemented on a printed card. The printed card is composed of a main extension plane, the IFA type antenna comprising: a first electrically conducting element, serving as a ground plane, a second electrically conducting element, serving as a radiating element of the antenna, an electrically conducting connection, serving to short-circuit the first electrically conducting element and the second electrically conducting element, and an excitation element being in electrical contact with the second electrically conducting element.

Secondly, the invention relates to a system, particularly for use in a motor vehicle comprising an IFA type antenna.

The invention applies to communicating objects or systems, the size of which is small compared with the wavelengths used for communication. Typically, the objects or systems concerned by the invention are terminals having dimensions of the order of a few centimeters operating in the ISM (Industrial Scientific Medical), UHF (Ultra High Frequency), VHF (Very High Frequency), SHF (Super High Frequency) and EHF (Extremely High Frequency) bands. The antennas which are fitted on such terminals have reduced dimensions in relation to the operating wavelengths (dimensions typically less than half the main operating wavelength). This characteristic feature of antennas defines a category of antennas commonly called miniature antennas.

With regard to miniature antennas, inverted F type antennas are known. Inverted F antennas are commonly called IFA (Inverted F Antenna) antennas. An IFA antenna consists of
a first electrically conducting element or ground plane,
a second electrically conducting element, commonly called the roof of the antenna serving as a radiating element of the antenna, most often arranged parallel to the ground plane (but which can also not be parallel to the ground plane),
an electrically conducting connection placed typically at a first end of the second electrically conducting element (or roof), which short-circuits the roof and the ground plane, and
an excitation element, e.g. a wire probe, placed in a second plane perpendicular to the ground plane, which is connected to a radio frequency source RF which creates a potential difference between the second electrically conducting element and the first electrically conducting element (or ground plane). The second end of the roof is generally in open circuit, it can be connected to a capacitor.

The length of the second electrically conducting element (or roof) is substantially equal to a quarter of the main wavelength of the antenna which makes the IFA type antenna relatively large compared with a preferred size of a communication system or device.

The present invention is particularly aimed at remedying the drawbacks of the known art, and particularly those cited above, and is also aimed at providing an IFA type antenna as well as a system comprising an IFA type antenna improved in such a way that the IFA type antenna can be produced (for a given operating frequency (or wavelength)) with a reduced size.

According to the invention, this aim is achieved by an IFA (‘Inverted F Antenna’ in English) type antenna being integrated into a printed card, the printed card having a main extension plane, the IFA type antenna comprising:
a first electrically conducting element, serving as a ground plane,
a second electrically conducting element, serving as a radiating element of the antenna,
an electrically conducting connection, serving to short-circuit the first electrically conducting element and the second electrically conducting element, and
an excitation element being in electrical contact with the second electrically conducting element,
   the second electrically conducting element comprising a first part, a second part and a third part,
   the first part of the second electrically conducting element being positioned in a first plane parallel to the main extension plane of the printed card,
   the second part of the second electrically conducting element being positioned in a second plane parallel to the main extension plane of the printed card,
   the third part of the second electrically conducting element being positioned in a third plane parallel to the main extension plane of the printed card,
   the first plane and the second plane being separated and the first and second part of the second electrically conducting element being connected by a fourth part of the second electrically conducting element, and
   the first plane and the third plane being separated and the first and third part of the second electrically conducting element being connected by a fifth part of the second electrically conducting element.

By virtue of such an embodiment of the IFA type antenna according to the present invention, it is advantageously possible to produce a reduced size of antenna since the length of the first part of the second electrically conducting element can be substantially less than a quarter of the operating wavelength of the antenna. Such an antenna according to the present invention may be called a ‘hybrid (printed and suspended) IFA antenna’.

According to the present invention, the resonating element of the antenna, i.e. the second electrically conducting element, comprises five parts which are not positioned in the same plane. The resonating element of the antenna is in some way folded for reducing the maximum length required to produce an antenna for a given resonance frequency.

According to the present invention, it is preferred
that the first part of the second electrically conducting element and the fourth part of the second electrically conducting element form an angle, particularly a right angle, and/or
that the first part of the second electrically conducting element and the fifth part of the second electrically conducting element form an angle, particularly a right angle, and/or
that the second part of the second electrically conducting element and the fourth part of the second electrically conducting element form an angle, particularly a right angle, and/or
that the third part of the second electrically conducting element and the fifth part of the second electrically conducting element form an angle, particularly a right angle.

According to the present invention, it is possible, according to one mode of embodiment, that the second part of the second electrically conducting element and the third part of the second electrically conducting element are positioned in different planes (i.e. that they are positioned in the second and third planes respectively). Moreover, it is also possible according to the present invention that the second plane and the third plane (while being parallel to the main extension plane of the printed card and parallel to the first plane) are positioned on different faces of the first plane. This means that the second part of the second electrically conducting element and the third part of the second electrically conducting element are folded on different sides with respect to the first part of the second electrically conducting element.

However, according to another mode of embodiment according to the present invention, it is preferred that the second plane and the third plane are identical.

By virtue of such an embodiment of the antenna according to the present invention, the IFA type antenna can be produced with a comparatively simple structure having elements or parts of elements of the antenna in two different planes, i.e. in a first plane and in a second plane (since the third plane corresponds to the second plane). In such an embodiment of the antenna according to the present invention, the second part and the third part of the second electrically conducting element are both positioned in the second plane (parallel to the main extension plane of the printed card).

A preferred development of the invention lies in the fact that the first part of the second electrically conducting element is positioned on a first side of the printed card, and that the second part of the second electrically conducting element and/or the third part of the second electrically conducting element is positioned or are positioned on a second side of the printed card, the second side being opposite to the first side of the printed card.

By virtue of such an embodiment of the IFA type antenna according to the present invention, it is advantageously possible to produce the antenna using both sides of the printed card.

According to yet another preferred mode of embodiment of the invention,
the first electrically conducting element,
the electrically conducting connection, and/or
the excitation element
   is positioned or are positioned on the first side of the printed card or on the second side of the printed card.

By virtue of such an embodiment of the IFA type antenna according to the present invention, it is advantageously possible to produce the IFA type antenna simply and cheaply.

According to a preferred mode of embodiment of the IFA type antenna according to the present invention, the printed card comprises a first opening for the fourth part of the second electrically conducting element and/or the printed card comprises a second opening for the fifth part of the second electrically conducting element.

According to another mode of embodiment of the IFA type antenna according to the present invention, it is preferred
that the first part of the second electrically conducting element has a first length of extension,
that the second part of the second electrically conducting element has a second length of extension,
that the third part of the second electrically conducting element has a third length of extension,
that the fourth part of the second electrically conducting element has a fourth length of extension,
that the fifth part of the second electrically conducting element has a fifth length of extension, and
that the total length (L) of the second electrically conducting element—typically corresponding to a quarter of the main operating wavelength of the IFA type antenna—corresponds to the sum of the first length, the second length, the third length, the fourth length and the fifth length.

By virtue of such an embodiment of the IFA type antenna according to the present invention, it is advantageously possible to reduce the size of the IFA type antenna considerably, particularly by more than 50% compared with the largest dimension (or extension) necessary for producing the second electrically conducting element having an effective total length of a quarter of the operating wavelength.

According to a preferred mode of embodiment of the IFA type antenna according to the present invention, a capacitor is provided between the first electrically conducting element and the second part of the second electrically conducting element.

This enables the antenna to be tuned to a lower frequency or the dimensions of the antenna (D2, L2, L1, L5 and L4) to be reduced.
The value of the input impedance of the antenna may be modified:
either by varying a first distance, between the electrically conducting connection and the excitation element,
or by varying the sum of the following lengths:
a second distance, between the excitation element and the location of the fifth part of the second electrically conducting element,
the first length,
the second length, and
the fourth length.

The present invention also concerns a system, particularly for use in a motor vehicle, comprising an IFA type antenna, the IFA type antenna being integrated into a printed card, the printed card having a main extension plane, the IFA type antenna comprising:
a first electrically conducting element, serving as a ground plane,
a second electrically conducting element, serving as a radiating element of the antenna,
an electrically conducting connection, serving to short-circuit the first electrically conducting element and the second electrically conducting element, and
an excitation element being in electrical contact with the second electrically conducting element,
   the second electrically conducting element comprising a first part, a second part and a third part,
   the first part of the second electrically conducting element being positioned in a first plane parallel to the main extension plane of the printed card,
   the second part of the second electrically conducting element being positioned in a second plane parallel to the main extension plane of the printed card,
   the third part of the second electrically conducting element being positioned in a third plane parallel to the main extension plane of the printed card,
   the first plane and the second plane being separated and the first and second part of the second electrically conducting element being connected by a fourth part of the second electrically conducting element,
the first plane and the third plane being separated and the first and third part of the second electrically conducting element being connected by a fifth part of the second electrically conducting element.

Other characteristics and advantages of the invention will emerge from reading the following description of a non-restrictive particular mode of embodiment of the invention.

### BRIEF DESCRIPTION OF THE DRAWINGS

The invention will be better understood from the description below, which relates to preferred modes of embodiment, given by way of non-restrictive examples, and explained with reference to the attached schematic drawings, in which:

FIG. 1 is a schematic representation of a side view of an IFA type antenna according to the prior art,

FIG. 2A is a schematic representation of a side view of an IFA type antenna according to the present invention,

FIG. 2B is a schematic representation of a top view of the IFA type antenna according to the present invention, and

FIG. 2C is a schematic representation of a bottom view of the IFA type antenna according to the present invention.

### DESCRIPTION OF THE DRAWINGS

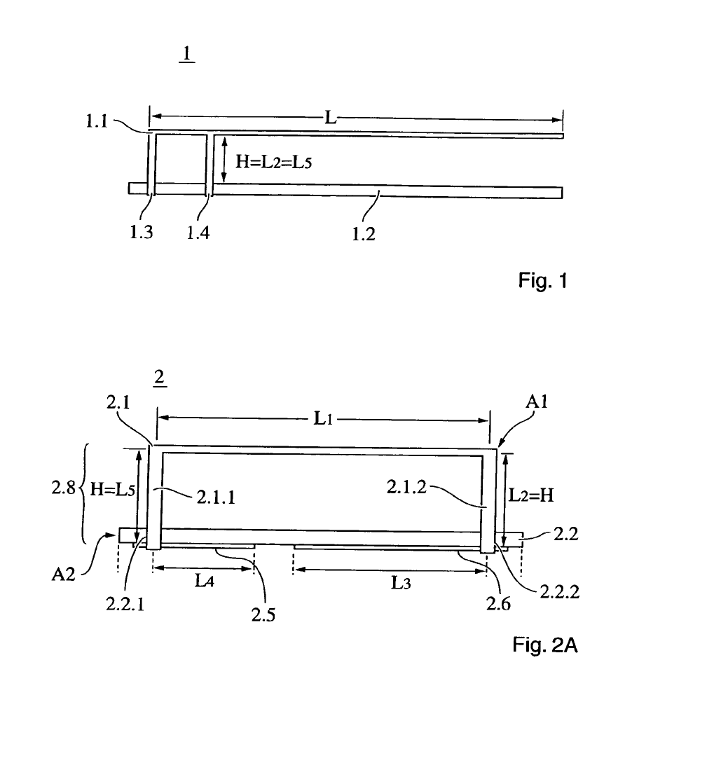

A schematic representation of a side view of an IFA type antenna according to the prior art is shown in FIG. 1.

The IFA type antenna 1 according to the prior art comprises a second electrically conducting element 1.1 which serves as a radiating element of the antenna 1 and which is oriented parallel to a printed card 1.2. The antenna 1 also comprises a first electrically conducting element which serves as a ground plane but which is not shown in FIG. 1. Normally, the first electrically conducting element is integrated into the printed card 1.2. The second electrically conducting element 1.1 is connected with the first electrically conducting element via an electrically conducting connection 1.3 which serves to short-circuit the first electrically conducting element and the second electrically conducting element 1.1. Moreover, the antenna 1 comprises an excitation element 1.4 (also called the base of the antenna 1) which connects the second electrically conducting element 1.1 with an RF circuit of the printed card 1.2.

The electrically conducting connection 1.3 link with the first electrically conducting element, and the excitation element 1.4 link with the circuit of the printed card 1.2 can be made via a weld. The antenna 1 assembly resembles an inverted F.

A distance of the second electrically conducting element 1.1 with respect to the first electrically conducting element (or ground plane) defines a height H of the antenna 1. The height of the antenna 1 corresponds to a length L2 of the excitation element 1.4 as well as a length L5 of the electrically conducting connection 1.3. The height H and the length L of the second electrically conducting element 1.1 define the input impedance of the antenna 1.

Moreover, the length L of the second electrically conducting element 1.1 is adapted to the resonance frequency of the antenna 1. The shorter the resonance frequency (and thus the wavelength is long), the longer length L must be.

A length L of the second electrically conducting element 1.1 of the antenna 1 (corresponding to a quarter of the operating wavelength (in the air) λₐᵢᵣ of the antenna 1) of approximately 17.7 cm, corresponds to a resonance frequency of 434 MHz. The height H corresponds, for example, to a tenth of the operating wavelength (in the air) λₐᵢᵣ of the antenna 1, i.e. approximately 1.7 cm. Accordingly, the antenna 1 according to the prior art must be relatively large with a resonance frequency of 434 MHz, and it is relatively difficult to integrate into small devices. Such devices are used in many fields of application, particularly in the automotive, telecommunications and in electronic data processing fields.

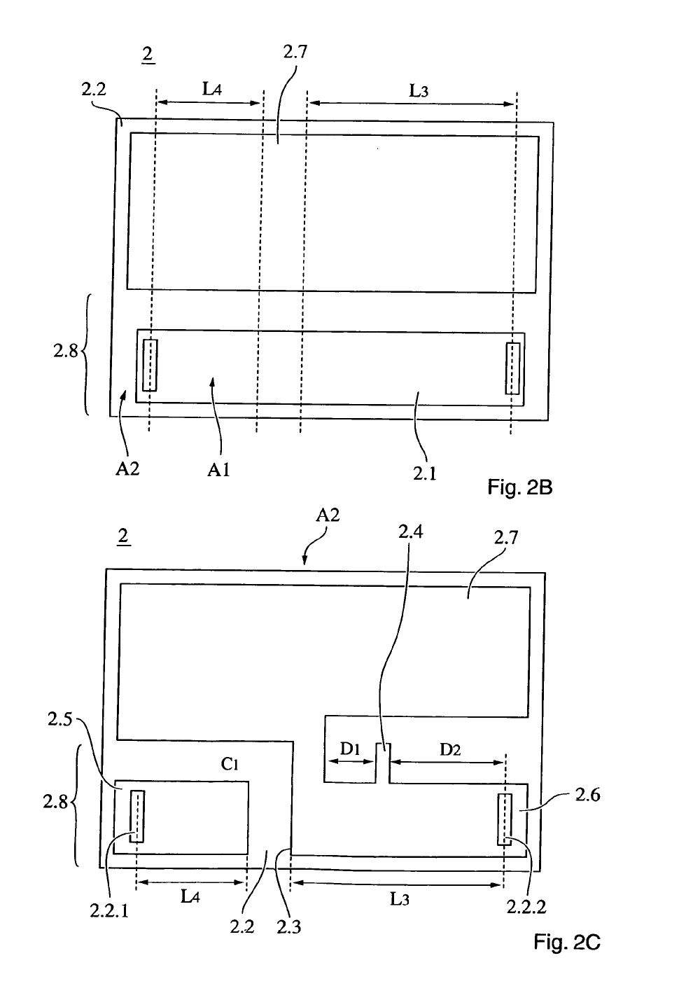

FIGS. 2A, 2B and 2C show an IFA type antenna 2 according to the present invention. FIG. 2A is a schematic representation of a side view of such an antenna, FIG. 2B is a schematic representation of a top view, and FIG. 2C is a schematic representation of a bottom view of such an antenna. A capacitor is shown in FIG. 2C. Such a capacitor is provided in a preferred mode of embodiment of the present invention, but this capacitor is only optional: in another preferred mode of embodiment of the present invention, such a capacitor is not present. In the description that follows, FIGS. 2A, 2B and 2C are all designated by the expression ‘FIG. 2’.

Like an IFA type antenna according to the prior art, the antenna 2 according to the present invention comprises a first electrically conducting element 2.7, serving as a ground plane, a second electrically conducting element 2.8, serving as a radiating element of the antenna, an electrically conducting connection 2.3, serving to short-circuit the first electrically conducting element 2.7 and the second electrically conducting element 2.8, and an excitation element 2.4 being in electrical contact with the second electrically conducting element 2.8.

In the example in FIG. 2, the IFA type antenna 2 according to the present invention comprises two main parts, a first main part A1 and a second main part A2. The first main part A1 comprises a first part 2.1 of the second electrically conducting element 2.8, the first part 2.1 of the second electrically conducting element 2.8 having a first length L1.

In the example in FIG. 2, the second main part A2 of the IFA type antenna 2 according to the present invention comprises a printed card 2.2 as well as the electrically conducting connection 2.3 and the excitation element 2.4. The electrically conducting connection 2.3 and the excitation element 2.4 are produced on one side (the bottom face) of the printed card 2.2. In another mode of embodiment (not shown in FIG. 2), the electrically conducting connection 2.3 and the excitation element 2.4 are produced on another side (the top face) of the printed card 2.2.

The first main part A1 can be made offset on the top (or bottom) of the second main part A2, e.g. floatingly above the second main part A2. The distance or the offset of the first main part A1 and the second main part A2 corresponds to a height H, and this height H corresponds to lengths L2 and L5 of elements (or parts) of the second electrically conducting element 2.8. The fourth length L5 corresponds to the fourth part 2.1.1 of the second electrically conducting element 2.8 and the fifth length L2 corresponds to the fifth part 2.1.2 of the second electrically conducting element 2.8.

In the example in FIG. 2, a fourth part 2.1.1 of the second electrically conducting element 2.8 is produced, for example, by a branch (also bearing the reference sign 2.1.1) having the fourth length L5. The fourth part 2.1.1 of the second electrically conducting element 2.8 connects the first part 2.1 of the second electrically conducting element 2.8 with the second part 2.5 of the second electrically conducting element 2.8. The second part 2.5 of the second electrically conducting element 2.8 has a second length L4. In the example in FIG. 2, it is particularly provided that the second part 2.5 of the second electrically conducting element 2.8 passes through a first opening 2.2.1 of the printed card 2.2.

In the example in FIG. 2, a fifth part 2.1.2 of the second electrically conducting element 2.8 is produced, for example, by a (second) branch (also bearing the reference sign 2.1.2) having the fifth length L2. The fifth part 2.1.2 of the second electrically conducting element 2.8 connects the first part 2.1 of the second electrically conducting element 2.8 with the third part 2.6 of the second electrically conducting element 2.8. The third part 2.6 of the second electrically conducting element 2.8 has a third length L3. In the example in FIG. 2, it is particularly provided that the third part 2.6 of the second electrically conducting element 2.8 passes through a second opening 2.2.2 of the printed card 2.2.

The second and third parts 2.5, 2.6 of the second electrically conducting element 2.8 are electrically isolated from one another. Preferably, the second and third parts 2.5, 2.6 of the second electrically conducting element 2.8 are printed on the printed card 2.2. In an example not shown in the figures, the second and third parts 2.5, 2.6 of the second electrically conducting element 2.8 are printed on the top face of the printed card 2.2.

The third part 2.6 of the second electrically conducting element 2.8 is connected to the first electrically conducting element 2.7 via the electrically conducting connection 2.3. It is preferred that the electrically conducting connection 2.3 as well as the first electrically conducting element 2.7 are produced via conducting tracks on the printed card 2.2, preferably by a printing method.

The excitation element 2.4 is also produced, preferably, as a conducting track on or in the printed card 2.2, particularly via a printing method. The excitation element 2.4 is electrically isolated from the first electrically conducting element 2.7.

The IFA type antenna 2 according to the present invention has the advantage—particularly due to the fourth and fifth parts 2.1.1, 2.1.2 of the second electrically conducting element 2.8 as well as the second and third parts 2.5, 2.6 of the second electrically conducting element 2.8, and a higher dielectric constant—of being of very reduced size (particularly the size L1 of the first part 2.1 of the second electrically conducting element 2.8) compared with a prior art IFA type antenna (for the same operating frequency (or wavelength) of the antenna).

In the mode of embodiment of the present invention as shown in FIG. 2C, a capacitor C1 is provided between the first electrically conducting element 2.7 and the second part 2.5 of the second electrically conducting element 2.8. This capacitor C1 is only optional, i.e. in another preferred mode of embodiment of the present invention, such a capacitor is not provided between the first electrically conducting element 2.7 and the second part 2.5 of the second electrically conducting element 2.8.

The mode of embodiment with the capacitor enables the antenna to be tuned to a lower frequency (compared to the configuration without a capacitor) or the space requirement of the antenna to be reduced by reducing its dimensions (D2, L2, L1, L5 and L4, i.e. reducing the dimension of the largest part of the second electrically conducting element 2.8).

The value of the input impedance of the antenna may be modified
either by varying a first distance D1, between the electrically conducting connection 2.3 and the excitation element 2.4,
or by varying the sum of the following lengths:
a second distance D2, between the excitation element 2.4 and the location of the fifth part 2.1.2 of the second electrically conducting element 2.8,
the first length L1,
the second length L4,
the fourth length L5, and
the fifth length L2.

In what follows, a calculation of the first length L1 of the first part 2.1 of the second electrically conducting element 2.8 is described for the case of the IFA type antenna 2 according to the present invention for a resonance frequency of 434 MHz for the case of a printed card 2.2 produced using fiberglass in the epoxy resin having the material designation ‘FR4’ (FR-4 being a fiberglass-reinforced epoxy resin composite and having properties in particular including a dielectric constant (Permittivity) of 4.70 max., 4.35 at 500 MHz, 4.34 at 1 GHz). In the calculation example, a dielectric constant of 4.6 was chosen.

### EXAMPLE

The wavelength in air λₐᵢᵣ is calculated according to:

$${λ}_{air} = \frac{C}{F} \qquad 1 )$$

with: C=speed
F=frequency
at a frequency of 434 MHz:
λₐᵢᵣ=69 cm. 2)

For the first part A1, the lengths L1, L2 and L5 are calculated according to

$$\begin{matrix}L 1 = \frac{{λ}_{air}}{10} = 6.9 cm & 3 ) \\ L 2 = \frac{{λ}_{air}}{40} = 1.7 cm \\ and & 4 ) \\ L 5 = \frac{{λ}_{air}}{40} = 1.7 cm . & 5 )\end{matrix}$$

The lengths L3 and L4 are calculated according to:

$$L 3 = L 4 = \frac{λ}{12} = \frac{{λ}_{air}}{12} \cdot \frac{1}{{( {ɛ}_{eff} )}^{0.5}} . \qquad 6 )$$

with: ∈_{eff}=effective dielectric constant.

The effective dielectric constant ∈_{eff} is calculated according to the following formula:

$$\begin{matrix}{ɛ}_{eff} = \frac{{ɛ}_{r} + 1}{2} + \frac{{ɛ}_{r} - 1}{2} \cdot ( 1 + \frac{10}{u} \text{?} \cdot u = \frac{w}{h} . \\ with & 7 ) \\ {ɛ}_{r} = \frac{ɛ}{{ɛ}_{0}} \\ \text{?} \text{indicates text missing or illegible when filed} & 8 )\end{matrix}$$

being the relative dielectric constant and the magnitudes a, b are calculated according to:

$$\begin{matrix}a = 1 + \frac{1}{49} ln [ \frac{{u}^{4} + {( u / 52 )}^{2}}{{u}^{4} + 0.432} ] + \frac{1}{18.7} ln [ 1 + {( \frac{u}{18.1} )}^{2} ] \\ and & 9 ) \\ b = 0.564 {( \frac{{ɛ}_{r} - 0.9}{{ɛ}_{r} + 3} )}^{0.053} & 10 )\end{matrix}$$

The precision of equations (7) to (10) is such that the error is less than 0.01% for u<1 and less than 0.03% for u<1000.

Thus, the effective dielectric constant ∈_{eff} is calculated for a substrate of the printed card 2.2 having the material designation ‘FR4’ at ∈_{eff}=3.9.

The lengths L3 and L4 can be calculated according to equation (6) as follows: L3, L4=2.8 cm.

The reduction in the required length of the IFA type antenna 2 according to the present invention (compared with the IFA antenna according to the prior art in FIG. 1) can therefore be obtained as follows:

$$\begin{matrix}L 2 + L 3 + L 4 + L 5 = \frac{{λ}_{air}}{40} + ( \frac{{λ}_{air}}{12} \cdot \frac{1}{{( {ɛ}_{eff} )}^{0.5}} ) + ( \frac{{λ}_{air}}{12} \cdot \frac{1}{{( {ɛ}_{eff} )}^{0.5}} ) + \frac{{λ}_{air}}{40} & 11 ) \\ L 2 + L 3 + L 4 + L 5 = \frac{{λ}_{air}}{20} + \frac{{λ}_{air}}{6} \cdot \frac{1}{{( {ɛ}_{eff} )}^{0.5}} . & 12 ) \\ L 2 + L 3 + L 4 + L 5 = \frac{{λ}_{air}}{20} + \frac{{λ}_{air}}{12} , & 13 ) \\ L 2 + L 3 + L 4 + L 5 = \frac{69}{20} + \frac{69}{12} . & 14 ) \\ L 2 + L 3 + L 4 + L 5 = 3.4 cm + 5.7 cm , & 15 ) \\ L 2 + L 3 + L 4 + L 5 = 9.1 cm . & 16 )\end{matrix}$$

Thus, it is possible according to the antenna 2 according to the present invention to reduce the required length (of 17.7 cm) by 9.1 cm (to 8.6 cm), thus giving a reduction of more than 51% compared with the prior art.

### LIST OF REFERENCE SIGNS

1 IFA type antenna according to the prior art
1.1 second electrically conducting element
1.2 printed card
1.3 electrically conducting connection
1.4 excitation element
H height
L length of the second electrically conducting element
2 IFA type antenna according to the present invention
2.1 first part of the second electrically conducting element
2.2 printed card
2.2.1 first opening
2.2.2 second opening
2.3 electrically conducting connection
2.4 excitation element
2.5 second part of the second electrically conducting element
2.6 third part of the second electrically conducting element
2.1.1 fourth part of the second electrically conducting element
2.1.2 fifth part of the second electrically conducting element
2.7 first electrically conducting element
2.8 second electrically conducting element
A1 first main part
A2 second main part
L1 first length
L2 fifth length
L3 third length
L4 second length
L5 fourth length
D1 first distance
D2 second distance
C1 capacitor

1. An IFA type antenna being integrated into a printed card, the printed card having a main extension plane, the IFA type antenna comprising:
a first electrically conducting element, serving as a ground plane;
a second electrically conducting element, serving as a radiating element of the antenna;
an electrically conducting connection, serving to short-circuit the first electrically conducting element and the second electrically conducting element; and
an excitation element being in electrical contact with the second electrically conducting element,
wherein the second electrically conducting element comprises a first part, a second part and a third part,
the first part of the second electrically conducting element being positioned in a first plane parallel to the main extension plane of the printed card,
the second part of the second electrically conducting element being positioned in a second plane parallel to the main extension plane of the printed card,
the third part of the second electrically conducting element being positioned in a third plane parallel to the main extension plane of the printed card,
the first plane and the second plane being separated and the first and second part of the second electrically conducting element being connected by a fourth part of the second electrically conducting element, the first plane and the third plane being separated and the first and third part of the second electrically conducting element being connected by a fifth part of the second electrically conducting element.

2. The IFA type antenna as claimed in claim 1, wherein the second plane and the third plane are identical.

3. The IFA type antenna as claimed in claim 1 wherein the first part of the second electrically conducting element is positioned on a first side of the printed card, and the second part of the second electrically conducting element and/or the third part of the second electrically conducting element is positioned or are positioned on a second side of the printed card, the second side being opposite to the first side of the printed card.

4. The IFA type antenna as claimed in claim 3, wherein
the first electrically conducting element,
the electrically conducting connection, and/or
the excitation element
is positioned or are positioned on the first side of the printed card or on the second side of the printed card.

5. The IFA type antenna as claimed in claim 1 wherein the printed card comprises a first opening for the fourth part of the second electrically conducting element and/or the printed card comprises a second opening for the fifth part of the second electrically conducting element.

6. The IFA type antenna as claimed in claim 1 wherein
the first part of the second electrically conducting element has a first length of extension,
the second part of the second electrically conducting element has a second length of extension,
the third part of the second electrically conducting element has a third length of extension,
the fourth part of the second electrically conducting element has a fourth length of extension,
the fifth part of the second electrically conducting element has a fifth length of extension,
the total length of the second electrically conductive element—typically corresponding to a quarter of the main operating wavelength of the IFA type antenna—corresponds to the sum of the first length, the second length, the third length, the fourth length and the fifth length.

7. The IFA type antenna as claimed in claim 1 wherein a capacitor is provided between the first electrically conducting element and the second part of the second electrically conducting element.

8. The IFA type antenna as claimed in claim 6 wherein the fourth and fifth length corresponds to a fortieth of the main operating wavelength of the IFA type antenna.

9. The IFA type antenna as claimed in claim 6 wherein the second and third length corresponds to a twelfth of the main operating wavelength of the IFA type antenna.

10. The IFA type antenna as claimed in claim 6 wherein the first length corresponds to a tenth of the main operating wavelength of the IFA type antenna.

11. A system for use in a motor vehicle, comprising an IFA type antenna, the IFA type antenna being integrated into a printed card, the printed card having a main extension plane, the IFA type antenna comprising:
a first electrically conducting element, serving as a ground plane;
a second electrically conducting element, serving as a radiating element of the antenna;
an electrically conducting connection, serving to short-circuit the first electrically conducting element and the second electrically conducting element; and
an excitation element being in electrical contact with the second electrically conducting element,
wherein the second electrically conducting element comprises a first part, a second part and a third part,
the first part of the second electrically conducting element being positioned in a first plane parallel to the main extension plane of the printed card,
the second part of the second electrically conducting element being positioned in a second plane parallel to the main extension plane of the printed card,
the third part of the second electrically conducting element being positioned in a third plane parallel to the main extension plane of the printed card,
the first plane and the second plane being separated and the first and second part of the second electrically conducting element being connected by a fourth part of the second electrically conducting element, the first plane and the third plane being separated and the first and third part of the second electrically conducting element being connected by a fifth part of the second electrically conducting element.
